(19) United States
(12) Patent Application Publication
(10) Pub. No.: US 2014/0244442 A1
(43) Pub. Date: Aug. 28, 2014

(54) METHOD FOR AUTOMATICALLY FILLING A VIRTUAL SHOPPING CART WITH ITEMS

(71) Applicant: Andrea Hirsch, New York, NY (US)

(72) Inventor: Andrea Hirsch, New York, NY (US)

(21) Appl. No.: 13/776,695

(22) Filed: Feb. 25, 2013

(51) Int. Cl. G06Q 30/06

(52) U.S. Cl. CPC G06Q 30/0633; G06Q 30/0625
USPC 705/26.62; 705/26.8; 705/26.7

(57) ABSTRACT

A method of automatically filling a Virtual shopping cart with items. Users automatically fill their Virtual shopping carts with a Predetermined List of Items that are required or recommended to create or complete a Product(s). The Method allows Users to automatically fill their Virtual or online shopping cart(s) with selected items in one easy step. Users can customize a List of Items and then automatically fill their Virtual shopping carts with the customized List of Items in one step. The Invention comprises of the Method of automatically filling a Virtual shopping cart in one step with a Predetermined List of Items, which may be complete or customized, for purchase, comprising of the following steps: Displaying a Predetermined List of Items and information about the items; Allowing a User to customize the group of items; Adding the complete or customized group of items to a Virtual shopping cart in one step.

### FIELD OF THE INVENTION

This Invention relates to a method of automatically filling a Virtual shopping cart with items. The Method allows Users to automatically fill their Virtual shopping carts with a Predetermined List of Items that are require or recommend to create or complete a Product(s). The Product(s) may be comprised of but not limited to at least one of the following: a kit(s), recipe(s), craft(s), project(s), craft project(s), art project(s), home improvement project(s), construction project(s), apparel or fashion idea(s), creation(s), design(s), outfit(s), fashion design(s), project(s), crafts, art project(s),or improvement project(s). The Method allows Users to automatically fill their Virtual or online shopping cart(s) with selected items in one easy step. The Method also allows Users to customize a List of Items and then automatically fill their Virtual shopping carts with the Customized List of Items in one step. The items may comprise of but are not limited to at least one of the following; components, stock keeping units, elements, segments, parts, and ingredients. The Invention comprises of the Method of automatically filling a Virtual shopping cart in one step with a Predetermined List of Items, which may be complete or customized, for purchase, comprising of the following steps: Displaying a Predetermined List of Items and also may display information about the items; Allowing a User to customize the group of items; Adding the complete or customized group of items to a Virtual shopping cart in one step.

### BACKGROUND OF INVENTION

As online shopping becomes increasingly popular, ways of quickening, enhancing, improving, and adding to the process for consumers are of great interest. The current state of the art still requires in many areas that consumers have to go through several steps to find a target item and then continue a laborious process to locate other target items. Often consumers have to visit a number of websites before they can find everything that they desire. Finding a seller that carries many or all the items that the consumer needs can be difficult, and the consumer ends up spending extra time and/or money on purchasing all the items that they are looking for. In addition, comparisons of items with regard to a variety of variables such as price, brand, availability, and shipping cost are limited for consumers.

Various methods of simplifying, enhancing, and speeding up online shopping and expediting the process for consumers are known in the field. For example, a system and method for electronic commerce, which analyzes the products that an individual purchases and generates a personalized electronic catalogue based on the user's purchase history, prior selections, and recent trends. Other examples include a method which assesses the needs of a user and generates the need of the user and displays a solution, and a system, which records, stores, and delivers data to a user after a label is scanned. The above examples disclose simplified ways of online shopping for users based on personal interests, needs, and search terms.

The present Invention integrates many areas of current interest for improvements in the field and comprises of many new and innovative features which expedites, enhances, and improve upon the current state of the art including but not limited to for example The Invention allowing consumers to enjoy expedited shopping process by facilitating that the User find all the items they need based on a Predetermined List of items required or recommended to create or produce a Product. The prior art also does not disclose a method to customize and group shopping; in the prior art a user still must individually select and add to their shopping carts items that they want to purchase or accept the entire group presented; this dilemma is also solved by the Invention.

### SUMMARY OF INVENTION

The Invention enables Users to enjoy greater convenience, speed, accuracy, choice, and simplicity when shopping Virtual (e.g. online) with ways of quickening, enhancing, improving, and adding to the process for Users. The Invention presents a method, which allows Users to automatically add customized groups of items selected from a Predetermined List(s) of items to their Virtual shopping cart in one step (e.g. mouse clicking on, selecting, or pressing one button or choosing one time). The Method may display information about each item, comprising available information regarding various categories such as price, brand, seller, description of items, shipping cost, delivery time, quality, availability, vendor, brand, manufacturer, retailer, distributor, and size.

Users have the ability to select items from a Predetermined List of items to their Virtual shopping cart based on criteria comprising of at least one or more among the following: price, quantity, availability, vendor, quality, delivery time, shipping costs, shipping method, brand, seller, manufacturer, retailer, distributor, size, and quality.

The items that may be automatically added to a Virtual shopping cart are selected by the User based on The Method Steps of: generating a Predetermined List which is then accepted by the User or User customized/altered. The items may comprise of but are not limited to at least one of the following; components, stock keeping units, elements, segments, parts, and ingredients.

The Product(s) may be comprised of but not limited to at least one of the following: a kit(s), recipe(s), craft(s), project(s), craft project(s), art project(s), home improvement project(s), construction project(s), apparel or fashion idea(s), creation(s), design(s), outfit(s), fashion design(s), project(s), crafts, art project(s),or improvement project(s).

The Predetermined List of items required may auto populate and the Method enables the User to customize (e.g. choose which items they want) before adding them to the shopping cart. If the User wants to purchase all the items, then the User only has to mouse click on, choose, select, or press one button or choose and all the items then are added to the User's shopping cart. The Method enables the User to purchase needed and/or required items based on the User's personal preferences, the criteria of which comprises, but is not limited to: price, brand, seller manufacturer, distributor, vendor, quantity, availability, shipping cost, quality, delivery time, measurement, and size.

The Method may involve the utilization of Two dimensional barcodes (“2D barcodes”). A User scans a 2D barcode and the Method automatically populates the device(s) being used by User with a Predetermined List of Items needed and displays information about the Product. The User may automatically fill the User's shopping cart with the auto populated items with the mouse click on, choose, select, or press on, press one button or choose, or unselect the items that they do not need. Another preferred embodiment of this invention incorporates the use of QR Codes.

The Invention allows the recognition of items that the User has previously selected or purchased and adjust the required items accordingly. The Method may also inform Users about grouping and associated discounts for shipping costs, available coupons, and any sale prices and/or other information or details on a variety of important criteria to be considered when User is making purchasing decisions.

The User controlled steps of the Method may be executed on any Electronic Device, including, but not limited to, computers, Smart phones, tablets, Mobile Devices, and any Devices with internet capabilities. The Method is applicable to various industries and may run on various platforms, including, but not limited to Microsoft, IBM, Apple, Android, and Blackberry.

Some of the Purposes of The Invention include, but are not limited to, simplifying Virtual shopping for Users, saving Users money, efficient comparison of items, and increasing revenues for sellers.
Additionally:
The Method may include the process of being able to photo something like a recipe in a book for example (with your Device, Mobile Device, mobile phone or camera) optically scan (scan) it and turn it into a shopping list, that can be shopped using character and/or image recognition. Also auto-filling a shopping cart can be processed through the phone, scanner, Device, or Mobile Device. Also an App or application can be created, that can process “Grand Ma's” recipe by photographing the recipe with a Device or Mobile Device or scanner, turn it into a list, shop it in whole or in part and then turn it into a Purchase order.

### BRIEF DESCRIPTION OF DRAWINGS

FIG. 1 shows a flowchart showing the logical steps of the Method according to this Invention.

FIG. 2 is a screenshot of part of a website page exhibiting a Method generated Predetermined List with required and/or recommended items.

FIG. 3 is a screenshot of a part of a web-page exhibiting a User's shopping cart after the cart is automatically filled with selected items.

FIG. 4 shows a flowchart showing the logical steps of the Method utilizing recognition of Product Information from Product Information Types according to the Invention.

FIG. 5 shows the process of being able to photo something like a recipe in a book for example (with your Device, Mobile Device, mobile phone or camera) optically scan (scan) it and turn it into a shopping list, that can be shopped using character and/or image recognition.

### DESCRIPTION OF A PREFERRED EMBODIMENT

The Invention presents a method, which allows Users to automatically add customized groups of items selected from a Predetermined List(s) of items to their Virtual shopping cart in one step (e.g. selecting or pressing one button one time).

The Method may display information about each item, comprising available information regarding various categories such as price, brand, seller, description of items, shipping cost, shipping method, delivery time, quality, and availability. Users have the ability to select items from a Predetermined List of items to their Virtual shopping cart based on criteria comprising of at least one or more among the following: price, quantity, availability, vendor, quality, delivery time, shipping costs, shipping method, brand, seller, manufacturer, retailer, distributor, size, and quality.

The items are based on a Predetermined List which is then selected or customized by the User. A preferred embodiment of this Invention is an application of the Invention in the field of arts and crafts in which the Predetermined List is of supplies needed or recommended for certain specific crafts projects (e.g. in this case crafts projects are finished Products).

In no way should this language be interpreted as an expressed limitation for this Invention to be limited in its use. This Invention is meant to be used and enables the Invention to be applied to various industries, including, but not limited to, fashion, food, construction, home improvement, and arts and crafts.

### DETAILED DESCRIPTION OF THE INVENTION AND DRAWINGS

In the following detailed description, reference is made to the accompanying drawings that form a part hereof, and in which is shown, by way of illustration, specific embodiments in which the Invention may be practiced. It is to be understood that other embodiments may be utilized and structural changes may be made without departing from the scope of the Invention. Numerous specific details are set forth herein in order to provide a understanding of various aspects of embodiments of the Invention. However, one or more embodiments of the Invention may be practiced without these specific details. In other instances, well-known methods, procedures, and/or components have not been described in detail so as not to unnecessarily obscure aspects of embodiments of the Invention.

The Invention comprises of the Method, which enables a User(s) to automatically fill the User's shopping cart with items. A preferred embodiment of the Invention involves the utilization of at least one Electronic Device, software executing the Method, the internet and/or a computer network.

The Method comprised of auto populating a list of required or recommended items based on a Predetermined List for creating a Product. Predetermined lists include but are not limited to: recipes, projects, arts and crafts projects, home improvement projects, construction projects, outfits, and apparel and fashion ideas, class supplies, supplies, camp supplies, suggested menu items, creation, or design. The required or recommended items may comprise of components and ingredients.

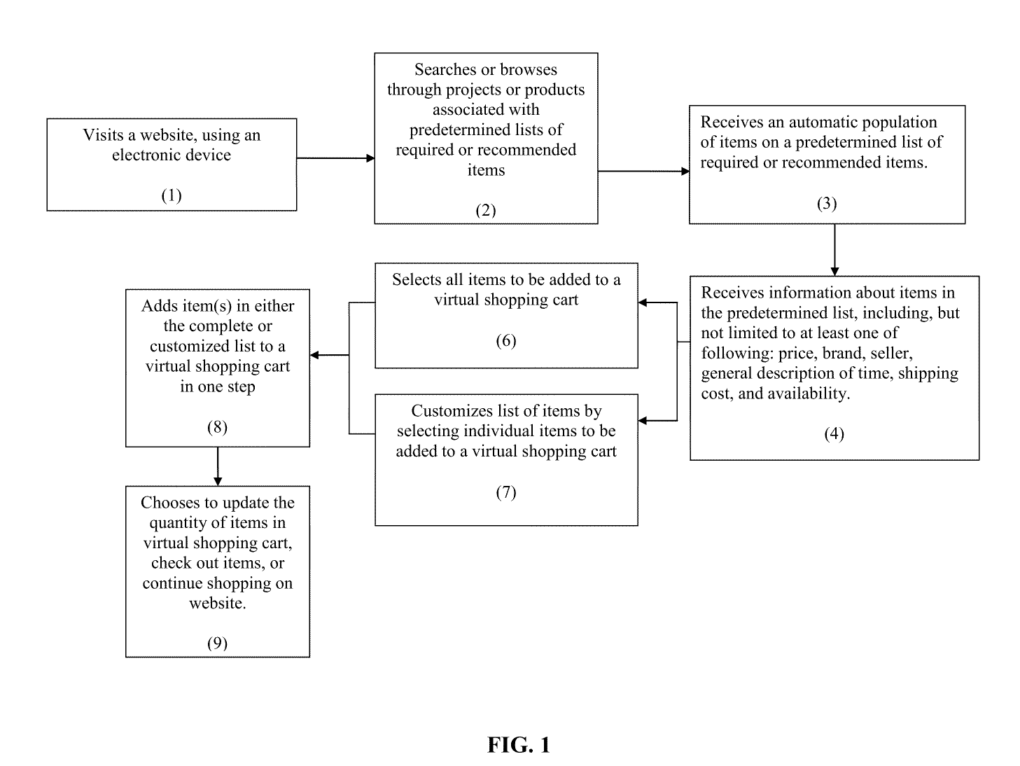

The steps involved in the Method as shown in FIG. 1. As an example a User visits a website (or photograph, written or printed materials, product boxes, packaging, labels, books, point-of-sale materials, recipes, magazines, ads, websites, newspapers, products, items, sounds, images. Product package, recipes, magazines, advertisements, and newspapers)

using a Mobile Device or other Electronic Device, which together with Users input and communication with a computer network and/or internet are jointly capable of executing the Method (1) and the User, usually in visiting a specific web-page or website, either searches or browses through projects and the associated with Predetermined Lists of required or recommended items (2). Once the User selects a Project(s) or Product(s), the Predetermined List automatically populates (3) such display may include additional information about the item, including, but not limited to at least one of the following: price, brand, seller, description of item, shipping cost and availability (4). User may select the items based on their personal preferences in terms of at least one of the following: price, quantity, stock keeping unit, time of delivery, availability, vendor, shipping costs, brand, manufacturer, retailer, distributor, size, and quality (5). The User may select either all items if the User wants to add all the items on the list to the User's shopping cart (6) or select the items that the User wants to add to the User's shopping cart (7) or deselect items User does not want (Customized List). The User may then add the complete or Customized List of Items to the User's Virtual shopping cart (8). After putting the auto populated and customized items into the cart, the User has the option of: a) updating certain criteria such as the quantity of the items and/or other criteria, b) checking out, or c) continuing shopping (9).

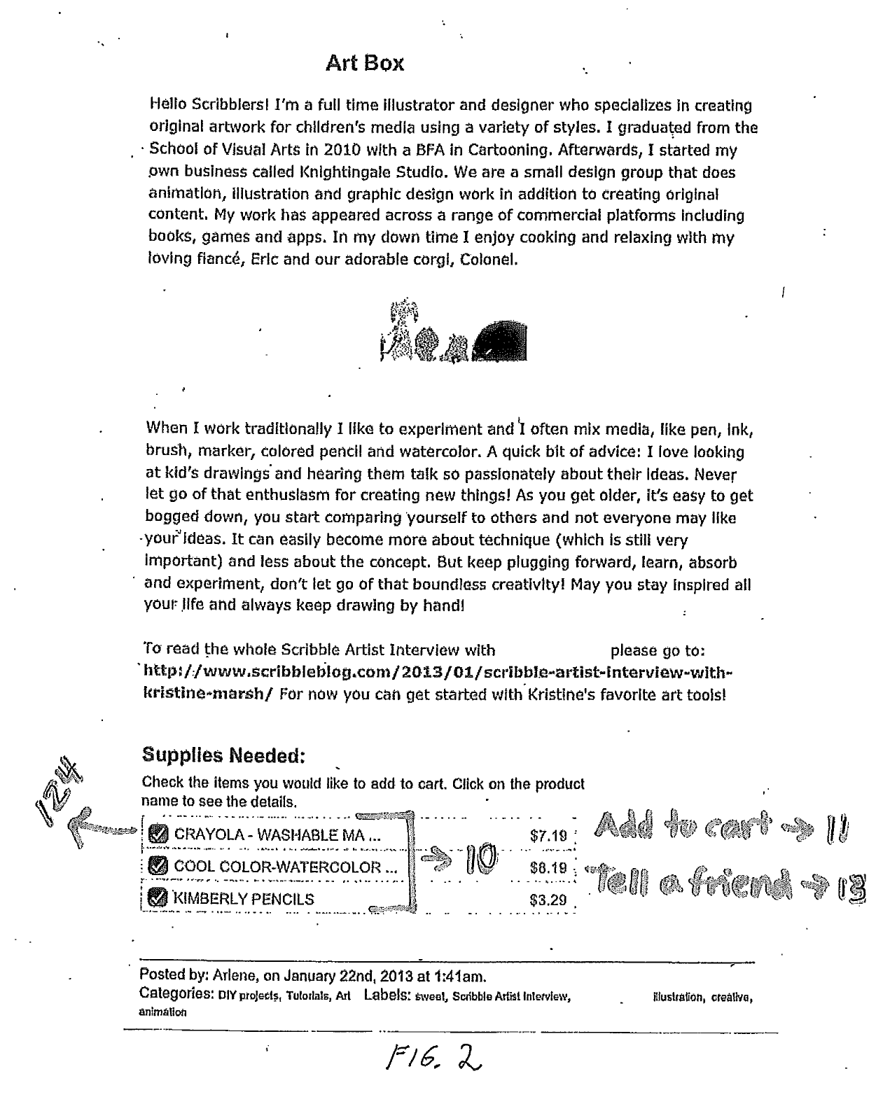

FIG. 2. shows one preferred embodiment of the Invention in the Arts & Crafts Field, in which the Predetermined List of items required is for a specific crafts Project. The materials needed for the crafts Project are listed (10). The User may choose to add all the required items from the Predetermined List into the User's shopping cart (11) or uncheck the items that the User does not need or want (12), so they would not be added to the shopping cart thereby customizing the list. The User may also inform others of the project, and the populate Predetermined List of Items required or recommended for the project, Customized List, or shopping cart items, by any communication method (13). After adding the automatically populated and then Customized List of Items to the User's shopping cart utilizing the one step process, the User may be navigated to the User's shopping cart. (One Step)

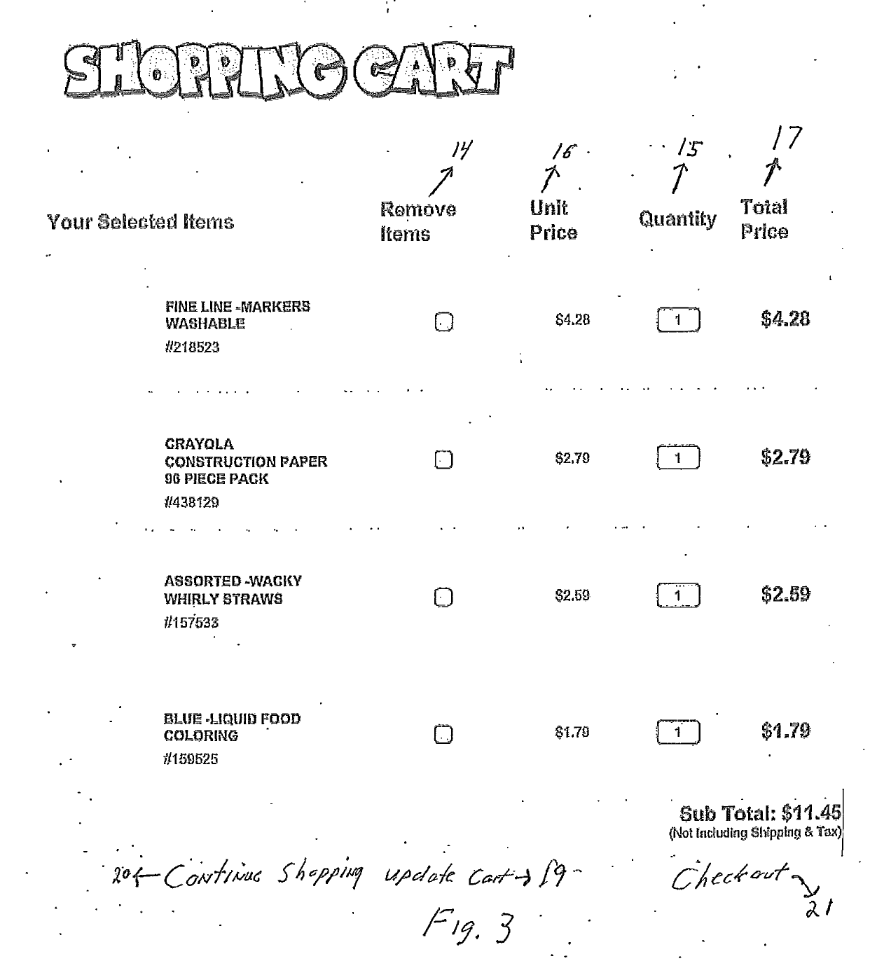

FIG. 3. shows a shopping cart and shopping cart Items. Items in the shopping cart may be removed (14) and the quantity and/or other variables of the Items may be updated (15). The price of the items can be displayed (16). Total price of each particular item may be shown (17). The subtotal before shipping and taxes can be displayed (18). The User may update the User's shopping cart (19) if the quantities of the items are updated or if items are removed. The User may also choose to continue shopping (20) instead of placing the order. Once the User is satisfied with the order, the User may hit the check out button (21) and complete the order.

Information about the items may be displayed in a foreign language selected by the User. The User may also select the price to be displayed in a foreign currency. The Method may also provide the User with different options for the required or recommended items. For example, if the Predetermined List is a recipe, and the recipe calls for peanut butter, different brands of peanut butter may be displayed, such as Skippy® or Jif® peanut butter, and different sellers of peanut butter, such as Wal-Mart® or Amazon® may also be displayed. Additional information such as prices, availability, shipping costs, size, color, weight, measurements, and other general information about the peanut butter may be displayed as well. If the Predetermined List is a fashion idea, the User may select the User's various measurements comprising of but not limited to at least one of the following: clothes, footwear, headwear and ring size. Not shown User may also be able to input preferences at any time prior to or during the Method.

The User, for all listed items, may select customized options that match their personal preference such options comprise of but are not limited to at least one of the following: price, availability, quality, brand, shipping cost, shipping time, and seller. The Method may also inform Users of discount group shipping if more than one item is being sold by the same seller. In addition, the Invention may identify previous items that the User purchased and if the User purchased one or more of the auto populated items previously, the User may be informed, the User then also may be given suggested adjustment options with regards to criteria including but not limited to at least one of price, seller, and various criteria as described above and the shopping cart can be adjusted accordingly.

If a Predetermined List calls for a very specific item, such as Nestle Tollhouse® chocolate chips and the item is out of stock, the Method may then execute to suggest other available alternatives, if any, such as Hershey® chocolate chips and inform the User of information such as when the item may be back in stock. Also the User can request alternative or preferred brands. The Invention may also then execute to identify other Product(s), projects, or kits with predetermined lists which require the same or similar lists of required or recommended items or products. The User may also optionally customize to select certain items from the Predetermined List and the Method may execute to additionally search for other Predetermined Lists associated with Product(s) or kits that also require the same selected item(s) or similar ones. The User may also search for predetermined items based on certain criteria, including but not limited to: age appropriateness, time to complete, cost, and free shipping.

The Method may also utilize Product Information Types, such as quick response codes (“QR Codes”), two dimensional barcodes (“2D barcodes”), one dimensional barcodes (“1D barcodes”), Universal Product Codes (“UPC”), Linear barcodes, barcodes, International Standard Book Numbers (“ISBN”), words, characters, photographs, drawings, images, smells, music, spoken words, and sounds. A preferred embodiment is one in which the Product Information Type is a QR code. Another preferred embodiment is one in which the Product Information Type is a 2D Barcode. 2D barcodes are available in a variety of places, including, but not limited to written or printed materials, product boxes, packaging, labels, books, point-of-sale materials, recipes, magazines, ads, websites, products, items, sounds, images. Product package, recipes, magazines, advertisements, and newspapers.

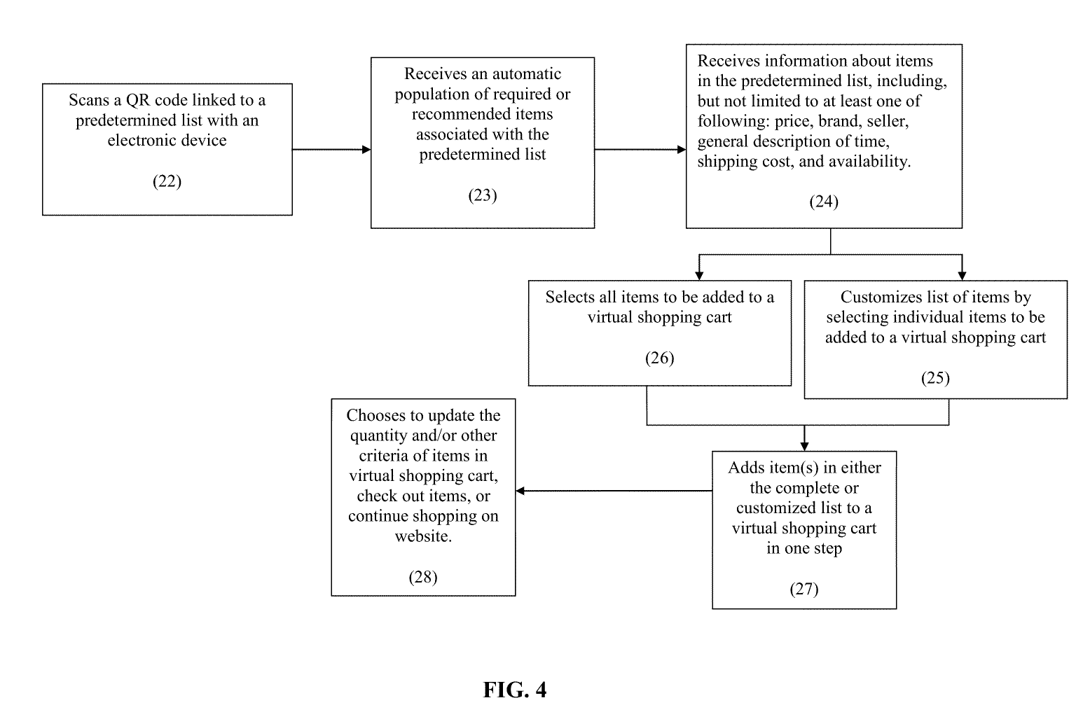

FIG. 4. shows the flowchart of how QR Codes are utilized in this Invention. Other Product Information Types can be utilized in a similar manor. The QR code is linked to a predetermined list. A User scans the QR code with an electronic device (22), the electronic device used comprises of at least one of the following: Smart phones, tablets, other mobile devices with internet capabilities, and optical readers. Upon scanning, the electronic device may display items needed based on the Predetermined List (23) and display information about the items (24). Information about the items include, but are not limited to, price, brand, seller, description of item, shipping cost and availability. User/User may select the items based on their personal preferences in terms of at least one of the following: price, quantity, availability, vendor, shipping costs, brand, manufacturer, retailer, distributor, size, volume, weight, and quality (25) or choose to add all items to the User's Virtual shopping cart (26). The User may then add the complete or Customized List of Items to the User's Virtual shopping cart (27). After selecting to auto populate items into the cart, the User has the option of updating the quantity of the items and/or other criteria, checking out, or continuing shopping (28).

The QR code may be available on recipes. The serving, brand, and/or portion sizes of the recipe may be selected, adjusted, customized, and the items may then adjust automatically based on the preferred portion or serving size. For example, a turkey meatloaf that serves eight people requires two pounds of ground turkey, but if the User only wants to make a turkey meatloaf that serves four people, the amount of ground turkey may automatically adjust to one pound. The other ingredients may adjust to the proper amount as well. The User does not have to manually adjust the items, but may add or select the auto adjusted items be sent (one step auto filled) to the User's shopping cart. The system may put the smallest saleable quantity into the cart.

The QR code may also be available for an outfit idea located or found in a written or printed materials, product boxes, packaging, labels, books, point-of-sale materials, recipes, magazines, ads, websites, newspapers, products, items, sounds, images. Once the QR code is scanned, all the items for the outfit are generated, as a pre-determined list, on the electronic device used to scan QR code. The User may select or customize the User's measurements for the various components of the outfit before selecting to auto add the components to the User's Virtual shopping cart.

The Method may be executed on a Device such as a Mobile Device or computer with internet capabilities. The Method may be executed using a mobile application or the browser of the Mobile Device. The Method may also be applied in a variety of industries, including not limited to food, arts and crafts, fashion, construction, and home improvement.

The Method may include the process of being able to photo something like a recipe in a book for example (with your Device, Mobile Device, mobile phone or camera) optically scan (scan) it and turn it into a shopping list, that can be shopped using character and/or image recognition.

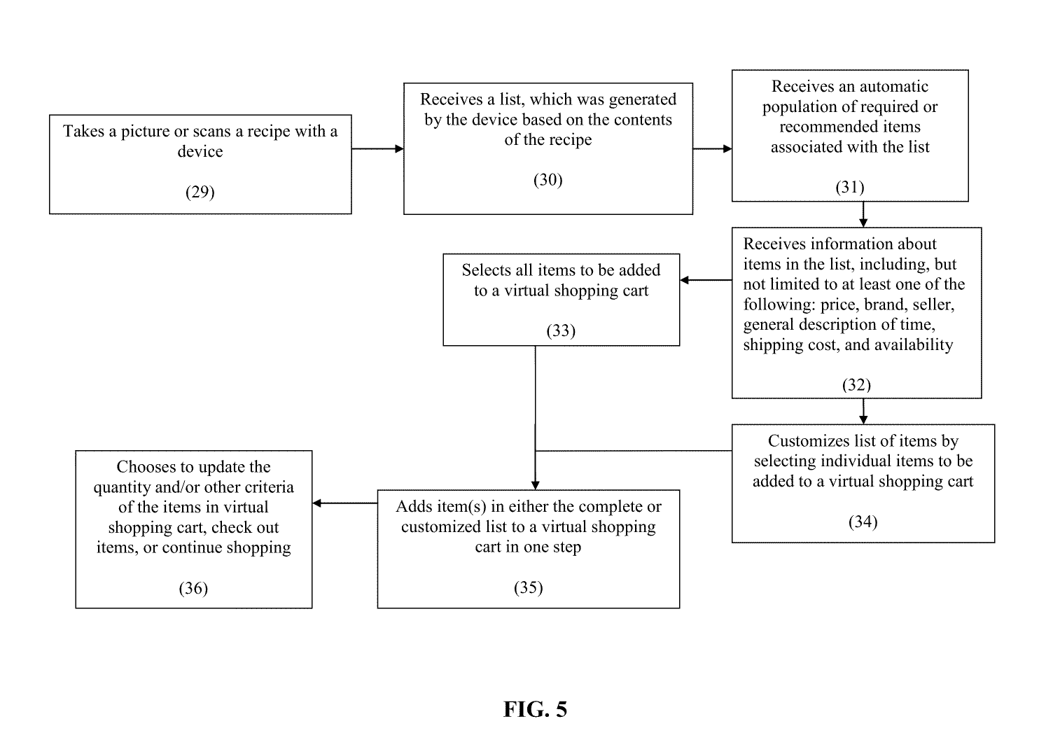

FIG. 5 A User takes a picture or scans a product, such as a recipe, with a device (29), which comprises of Smart phones, tablets, other mobile devices with internet capabilities, and optical readers. The User may receive a list, which is generated by the device based on the contents of the recipe (30). The User may receive an automatically populated list of required or recommended items associated with the list (31). The User may receive information about the items (32). Information about the items include, but are not limited to, price, brand, seller, description of item, shipping cost and availability. User/User may select the items based on their personal preferences in terms of at least one of the following: price, quantity, availability, vendor, shipping costs, brand, manufacturer, retailer, distributor, size, and quality (33) or choose to add all items to the User's Virtual shopping cart (34). The User may then add the complete or customized List of Items to the User's Virtual shopping cart (35). After selecting to auto populate items into the cart, the User has the option of updating the quantity and/or other criteria of the items, checking out, or continuing shopping (36).

### DEFINITIONS

These definitions are in addition to the words and phrases specifically defined in the body of this application.

Kit: Supplies (both included and/or required or suggested but not included) and/or instructions to use the supplies to create a Product which is an object(s) of the Kit, which is created by the utilization and combination of various items in accordance with instructions to utilization and combination of the items to create the Product(s).

Product: The finished or completed result from the utilization and combination of various items in accordance with and based upon instructions related thereto.

Seller(s): a party that offers, or enters into contracts to make a sale to an actual or potential buyer; also a vendor, distributor, wholesaler, licensee, licensor, manufacturer, or retailer.

Predetermined List: A List of Items which are needed or recommended to have or create a Product(s), for example a list of ingredients found in a recipe, a list of components and/or supplies required or recommended in the instructions for a crafts project, or a knitting pattern. Also Predetermined Group.

Customized List: is a Predetermined List displayed for the User to review and thereafter accept as is or alter or modify.

Mobile Device: is a generic term used to refer to a variety of devices that allow people to access data and information. A Mobile Device (can be also known as a handheld computing device, handheld device, handheld computer or simply handheld) can also be hand-held computing device, which can have a display screen which can also have a touch input and/or a miniature keyboard.

A handheld computing device: can have an operating system (OS), and usually can run various types of application software, known as apps. Most hand held devices can also be equipped with WI-FI, Bluetooth and GPS capabilities that can allow connections to the Internet and other Bluetooth capable devices such as an automobile or a microphone headset. A camera and/or media player feature for video or music files can also be typically found on these devices along with a stable battery power source. Other types of Mobile Devices include tablet computers. As in a personal digital assistant (“PDA”), the input and output are often combined into a touch-screen interface, Smartphones and PDAs Enterprise Digital Assistants may offer integrated data capture devices like barcode, RFID, optical, Optical Character Recognition, and smart card readers.

Quick Response Codes (“QR Codes”): QR Codes are a type of a matrix barcode, which are optical machine-readable labels usually attached or printed to items that record information related to the item. QR Codes are available in a variety of places, including, but not limited to written or printed materials, product boxes, packaging, labels, books, point-of-sale materials, recipes, magazines, ads, websites, newspapers, products, items, sounds, images. product package, recipes, magazines, advertisements, and newspapers.

Two Dimensional Barcode (“2D Barcode”): a two-dimensional way to represent information both by vertical and horizontal patterns. 2D barcodes are also known as quick response codes because they enable fast data access. 2D barcodes are often used in conjunction with smart phones. The user simply photographs or scans a 2D barcode with the camera on a phone equipped with a barcode reader. The reader interprets the encoded URL, which directs the browser to the relevant information on a Web site. This capability has made 2D barcodes useful for mobile marketing. Some 2D barcode systems also deliver information in a message for users without Web access.

Virtual: occurring, relating to, or existing within a virtual reality or for all practical purposes an existence which is possible or inferred.

Items: any object of attention, concern, or interest. Items may include but are not limited to supplies, elements, parts, ingredients, components, and products.

Outfits: a set of tools or equipment especially for the practice of a trade, also a clothing ensemble often for a special occasion or activity.

Device: Comprises of at least one of Electronic Device, computer, Mobile Device, digital scanner, image scanner, scanner, handheld device, reader device, server,

Electronic Device: a device that accomplishes its purpose electronically.

Digital Scanner, Image Scanner—an electronic device that generates a digital representation of an image for data input to a computer.

Product Information Types: QR Codes, 2D barcodes, 1D barcodes, UPC Codes, MVS Mobile Visual Search, Linear barcodes, barcodes, International Standard Book Number ISBN codes, words, characters, photographs, drawings, images, spoken words, music, sounds, smells.

Product Information: Information on a Product(s) stored in or on Product Information Types.

List of Items: a group or List of Items consisting of at least one item.

The foregoing description of at least one current preferred embodiment of the Invention has been presented for the purposes of illustration and description.

While multiple embodiments are disclosed, still other embodiments of the Invention may become apparent to those skilled in the art from the above detailed description, (as well as the specification, and claims herein), which shows and describes illustrative embodiments of the Invention. As will be realized, the Invention is capable of modifications in various obvious aspects, all without departing from the spirit and scope of the Invention. Accordingly, the detailed description is to be regarded as illustrative in nature and not restrictive. Also, although not explicitly recited, one or more embodiments of the Invention may be practiced in combination or conjunction with one another. The idea, creation, formulation and methodology of a method of auto-filling an online or Virtual shopping cart in one step (or in any other comparable format, process form of communications or other technology now known or hereafter devise) with selected items for purchase comprising customization of listings, reverse search capabilities, software criteria adjustments and the utilization of Product Information Types such as QR Codes all of which are examples of the intended utilization, but are not to be construed or interpreted to limit the scope of the Invention or its use. Furthermore, the reference or non-reference to a particular embodiment of the Invention shall not be interpreted to limit the scope the Invention. It is intended that the scope of the Invention not be limited by this detailed description or the specification.

What is being claimed:

1. A method of automatic filling a virtual shopping cart in one step with a predetermined List of Items, which can be complete or customized, for purchase, comprising of the following steps:
a. Displaying a predetermined List of Items and information about the items;
b. Customizing the List of Items;
c. Selecting the List of Items;
d. Adding the complete or customized List of Items to a virtual shopping cart in one step.

2. The method of claim 1, further comprising of the following steps:
a. Using software that executes on a computer network based system;
b. Utilizing at least one host server to communicate with at least one user operated device;
c. Using the internet (World Wide Web) for at least one of communicating, transmitting, storing, and receiving data and information;
d. At least one of receiving, inputting, and storing information in at least one database;
e. Using the information stored in the database to generate at least one group or List of Items.

3. The method of claim 1, wherein the at least one database is located on the at least one host server.

4. The method of claim 1, is further comprised of the additional step of displaying items only from seller(s) having information stored in the database.

5. The method of claim 2, whereby the user operated device comprises at least one of the following: computers, Smart phones, tablets, mobile devices, and any electronic devices with internet capabilities.

6. The Method of claim 1, whereby the predetermined list is required or recommended to create a product or finished result from the utilization and combination of the predetermined group or List of Items in accordance with instructions.

7. The method of claim 1, wherein the product comprises of at least one of the following: a kit(s), recipe(s), craft(s), project(s), craft project(s), art project(s), home improvement project(s), construction project(s), apparel or fashion idea(s), creation(s), design(s), outfit(s), fashion design(s), project(s), crafts, art project(s),or improvement project(s).

8. The method of claim 1, whereby when items which are out of stock or unavailable;
further comprising the steps of automatic searching and then displaying substitute items that have been located.

9. The method of claim 1, further comprised of the step whereby the user selects from searchable criteria and options, comprised of various rights of election including, but not limited to, at least one of the following, time needed to complete, least expensive, appropriate age group if applicable, and free shipping, to customize a predetermined list.

10. The method of claim 1, whereby the item(s) in the predetermined list(s) are used in additional search(s) for other additional products, kits, or crafts that require the item(s).

11. The method of claim 1, wherein the items comprise of at least one of the following;
supplies, components, elements, segments, parts, and ingredients.

12. The method of claim 1, whereby any information, words or language created or displayed on any devise by executing the method are translated and displayed in at least one user selected additional or foreign language.

13. The method of claim 1, whereby the information in claim 1 step a. comprises of at least one of the following: price, brand, quantity, description, quality, seller(s) of the items, shipping cost, shipping method, volume, weight, measurement, delivery time, availability, vendor, brand, manufacturer, retailer, distributor, and size.

14. The method of claim 13., whereby price is converted to and displayed in a user selected equivalent foreign currency.

15. The method of claim 1, further comprises a step whereby the user elects to modify at least one of the items.

16. The method of claim 15, whereby the modification further comprises the step of modifying at least one of the following: price, size, weight, volume, measurement, quantities to purchase, brand, and seller of at least one of the items.

17. The method of claim 15, whereby modifications are based on the user's personal preference, inclination or parity.

18. The method of claim 1, further comprised of providing the user with an option to remove items before the items are put in the shopping cart or remove items after they have been placed in the shopping cart.

19. The method of claim 18, further comprised of providing the user with an option to remove items before the items are put in the shopping cart by unselecting them.

20. The method of claim 18, further comprised of the step of, whereby items in the predetermined list can be selected by the user prior to being added to the virtual shopping cart user.

21. The method of claim 20, whereby additional searches for additional products based on the selected List of Items are performed for additional: kits, crafts, or products, whereby the selected List of Items are also recommended or required in part or in whole.

22. The method of claim 21, whereby the method automatically provides this search without user prompt.

23. The method of claim 1, further comprising of the step of allowing the user to add all selected or customized items to the shopping cart with one press of one button.

24. The method of claim 1, further comprising of automatic recognition of selected items that the user had previously purchased and adjusting items to be added into the shopping cart accordingly.

25. The method of claim 1, further comprised identification of items being sold by at least one of the following: seller, distributor, retailer, manufacturer, or vendor.

26. The method of claim 25, further comprising of the step of calculating discounts for group shipping of items from at least one of: seller(s), distributor, retailer, manufacturer, or vendor.

27. The method of claim 13, further comprising the step of utilization of product information types collected from sources comprised of at least one of the following: QR codes, 2D barcodes, 1D barcodes, UPC Codes, MVS Mobile Visual Search, Linear barcodes, barcodes,
International Standard Book Number ISBN codes, words, characters, photographs, drawings, images, spoken words, music, sounds, smells.

28. The method of claim 27, whereby the product information can be available in various locations comprised of at least one of the following: written or printed materials, product boxes, packaging, labels, books, audio books, point-of-sale materials, recipes, magazines, ads, websites, newspapers, products, items, sounds, photographs, images.

29. The method of claim 27, further comprising of the step whereby a user scans at least one product information type with at least one of the following: a mobile device, camera, device, scanner, or electronic device.

30. The method of claim 27 further comprising of the step, whereby the product information is recognized and linked to a predetermined List of Items needed.

31. The method of claim 27, whereby the product information is available on a recipe or other type product and the items needed for the recipe can be adjusted based on at least one of the following criteria comprising: brand, quality, price, seller, vendor, retailer, distributor, shipping costs, measurement, quantity, availability, size, weight, measurement, volume, portion size, and serving size.

32. The method of claim 27, whereby the product information is available on at least one of the following comprising: outfits, accessories, headwear, clothing, footwear, outerwear, apparel or fashion idea, creation, or design and the items needed can be adjusted based on an User's various measurements.

33. The method of claim 2, whereas the user operated electronic device is a mobile device.

34. The method of claim 33, whereas the method is executed further using a software application stored on the device, or mobile device.

35. The method of claim 34, whereas the method is executed further using a browser of a device or mobile device with internet capabilities.

36. The method of claim 1, wherein the method can be applied to any industry and type of goods, products, byproducts, and services.

37. The method of claim 18, further comprised of providing the user with an option to remove or add items after the items are put in the shopping cart.

38. An internet based system for providing users with an automatically populated List of Items, which they may select or customize to add to their virtual shopping cart in one step, said internet based system comprising:
a. At least one database on or available to at least one host server storing information describing a plurality of groups of items, the database further comprising:
1. A means to manually enter groups of items associated with predetermined lists of items;
2. A means to automatically input groups of items associated with predetermined lists of items;
3. A means to search for at least one online seller selling the items associated with predetermined list(s) of items;
b. Providing at least one database and at least one host server, which can communicate with a plurality of user operated devices, electronic devices or mobile devices; the host server further comprising:
1. A means to automatically formulate a group of items when a query about predetermined lists is made on the user operated electronic or mobile device;
2. A means to automatically search for information about each item in a group of items;
3. A means to automatically display the group of items and the respective information about each item on the user operated device;
4. A means to receive and process an order containing a user's selection of the group of items when submitted in one step by the user.

39. The method of claim 38 whereby at least one host server comprises of at least one of a computer, device, electronic device, or mobile device.

40. The method of claim 38 whereby at least one database is located on at least one host server.

41. The method of claim 38 whereby at least one database is not located on at least one host server.

42. The method of claim 38 whereby at least one host server is a mobile device.

43. The method of claim 2, whereby the software is a in part or in whole a mobile application.

44. The method of claim 2, whereby the at least one host server to communicate with at least one user operated device comprises of at least one of a computer, device, electronic device, or mobile device.

45. The method of claim 2 whereby the internet (World Wide Web) used for at least one of communicating, transmitting, storing, and receiving data and information is the internet (World Wide Web) or its equal at any given time.

46. The method of claim 2 whereby the at least one computer network based system comprises of at least one mobile device.

47. The method of claim 1, further comprising of automatic recognition of a particular seller that the user had previously purchased and adjusting items to be added into the shopping cart accordingly.
